(19) United States
(12) Patent Application Publication
(10) Pub. No.: US 2012/0214146 A1
(43) Pub. Date: Aug. 23, 2012

(54) INTERACTIVE LEARNING SYSTEM

(75) Inventors: Hsiu-Ping Yueh, Taipei (TW); Chih-Ting Lin, Taipei (TW); Yuan-Chen Liu, Taipei (TW); Shih-Kuan Hsu, Taipei (TW)

(73) Assignee: NATIONAL TAIWAN UNIVERSITY, Taipei (TW)

(21) Appl. No.: 13/155,931

(22) Filed: Jun. 8, 2011

(30) Foreign Application Priority Data
Feb. 23, 2011 (TW) 100105935

(51) Int. Cl. G09B 5/00; G09B 7/00

(52) U.S. Cl. 434/307 R; 434/362

(57) ABSTRACT

An interactive learning system includes a sensing network constituted by a plurality of sensing/transmitting modules, and a transmission network formed by the sensing network and a data processing device. The sensing/transmitting modules sense movements and vibrations thereof and interactive statuses between the sensing/transmitting modules and other sensing/transmitting modules, so as to generate messages that indicate the movements, the vibrations and the interactive statuses, and transmit the sensed messages to the data processing device by the transmission network, for interactive messages to be displayed through a human-machine interface of the data processing device. As such, learners' conceptions can be perceived and shown by the actual operations of the sensing/transmitting modules, which allows teachers to grasp learners' conceptions and thereby increase their interactions.

### BACKGROUND OF THE INVENTION

1. Field of the Invention

This invention relates to interactive learning systems, and, more particularly, to an interactive learning system having a plurality of physical sensing/transmitting modules and a data processing device.

2. Description of Related Art

As facing a new concept, learners in a traditional class may comprehend new knowledge and be aware of self-insufficiency in knowledge, through integrating old knowledge with the new concepts. The learners may also join a group, and interact with other people in the group, in order to expedite the learning efficiency and to develop a team spirit. On the other hand, the course of learning is valuable for teachers, in that the course may reveal issues such as likely-confusing concepts and miscomprehended knowledge, and may facilitate the understanding of the learners' thinking, so as to improve the teaching skill in the future.

In general, students answer questions in two ways, physical operation and computer software operation. The physical operation includes a variety of tools, such as paper card, post-in, paper and pens. The physical operation creates an atmosphere in which teachers may discuss and cooperate with one another; however, the paper cards need to be redrawn once the architecture changes. The physical operation provides final answers only. In other words, teachers are not able to learn the process during which the students answer the questions. The physical operation cannot be appended with multi-media examples. Compared with the physical operation, the computer software operation allows users to easily move, organize answer architecture, and record the whole operation process. The computer software operation, however, has a drawback in that group members do not interact with one another. The computer software operation displays information in a 2-D manner, and cannot provide a 3-D perception. Especially, if the concept has complicate levels, the 2-D manner limits the display of concepts and connections in drawings, and affects learners' understanding.

It is required, for an interactive teaching tool, to expedite the learners' understanding and absorption to the new knowledge, to establish an interactive and communicating bridge between the teachers and learners, and to help the teachers to evaluate learning outcomes. Therefore, how to provide an interactive learning system that has both the advantages of the physical and software operations, in order to overcome the drawbacks of the conventional teaching tools, is becoming one of the most unsolved issues in the art.

### SUMMARY OF THE INVENTION

In view of the above-mentioned problems of the prior art, the present invention provides an interactive learning system, which comprises: a plurality of sensing/transmitting modules that constitute a sensing network, the sensing/transmitting modules sensing movements and vibrations thereof and interaction statuses between the sensing/transmitting modules and other sensing/transmitting modules, so as to generate interaction messages that indicate the movements, the vibrations and the interaction statuses; and a data processing device that forms a transmission network together with the sensing/transmitting modules, the data processing device receiving the interaction messages generated by the sensing/transmitting modules, and displaying and/or inputting the interaction messages through a human-machine interface.

In an embodiment of the present invention, the sensing/transmitting modules correspond to predetermined learning messages, and the data processing device comprises a database that is used for pre-storing identification messages of the sensing/transmitting modules and correlation messages of the sensing/transmitting modules and their corresponding predetermined learning messages, the data processing device, upon receiving the interaction messages, further generating learning status messages according to the interaction messages, the identification messages and the correlation messages, and displaying the learning status messages through the human-machine interface, the learning status messages being further stored in the database.

In an embodiment of the present invention, the interactive learning system further comprising an intermediate module that interfaces the sensing/transmitting modules with the data processing device, and converts messages generated by the sensing/transmitting modules and the data processing device into another messages in a format readable by the sensing/transmitting modules and the data processing device, so as to allow the another messages to be transmitted between the sensing/transmitting modules and the data processing device.

In an embodiment of the present invention, the intermediate module and the sensing/transmitting modules form a star or a tree network topology.

In an embodiment of the present invention, the intermediate module is connected to the sensing/transmitting modules in a wired or wireless manner.

In an embodiment of the present invention, each of the sensing/transmitting modules comprises: a sensing unit that senses the movements and vibrations of the sensing/transmitting modules and the interaction statuses between the sensing/transmitting modules and the other sensing/transmitting modules; a transmitting unit that transmits/receives messages to/from the other sensing/transmitting modules; a storing unit that stores predetermined messages or messages received through the transmitting unit; a message inputting/outputting unit that allows operation instructions to be input therein and displays a status of the sensing/transmitting module itself; a processing unit that processes messages of the sensing unit, the transmitting unit, the storing unit and the message inputting/outputting unit; and a power supply unit that supplies power to the sensing unit, the transmitting unit, the storing unit, the processing unit and the message inputting/outputting unit.

In an embodiment of the present invention, the message inputting/outputting unit comprises keys and/or switches for inputting the operation instructions, and a liquid crystal display for displaying the status of the sensing/transmitting module itself.

In an embodiment of the present invention, the human-machine interface comprises a displaying unit that displays messages, and an inputting unit that allows messages to be input therein.

In an embodiment of the present invention, the sensing/transmitting modules constitute the sensing network in a wired or wireless manner.

In an embodiment of the present invention, the sensing/transmitting modules and the data processing device form the transmission network in a wired or wireless manner.

In an embodiment of the present invention, the sensing/transmitting modules receive messages through the data processing device via the transmission network.

Compared with the prior art, the interactive learning system comprises a sensing network that is constituted by a plurality of sensing/transmitting modules, and a transmission network that is constituted by the sensing network and a data processing device. The sensing/transmitting modules sense movements and vibrations thereof and interaction statuses between the sensing/transmitting modules and other sensing/transmitting modules, and generate messages that indicate the movements, the vibrations and the interaction statuses. The sensing/transmitting modules transmit messages through the transmission network to the data processing device, and the human-machine interface of the data processing device displays the interaction messages. As such, learners' conceptions can be perceived and shown by the actual operations of the sensing/transmitting modules, which allows teachers to grasp learners' conceptions and thereby increase their interactions.

### BRIEF DESCRIPTION OF DRAWINGS

The invention can be more fully understood by reading the following detailed description of the preferred embodiments, with reference made to the accompanying drawings, wherein:

FIG. 1A is an application architectural diagram of an interactive learning system of a first embodiment according to the present invention;

FIGS. 1B and 1C are operation schematic diagrams of the interactive learning system of the first embodiment;

FIG. 2A is an application architectural diagram of an interactive learning system of a second embodiment according to the present invention;

FIGS. 2B and 2C are operation schematic diagrams of the interactive learning system of the second embodiment;

FIG. 3 is an application architectural diagram of an interactive learning system of a third embodiment according to the present invention; and

FIGS. 4A and 4B are application architectural diagrams of an interactive learning system of a fourth embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

### The First Embodiment

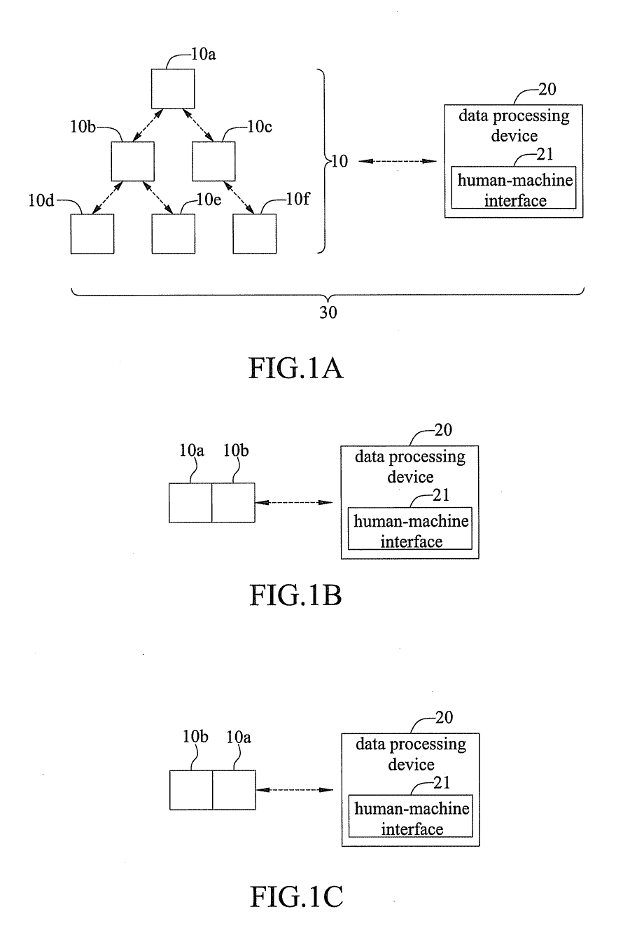

FIG. 1A is a system architectural diagram of an interactive learning system according to the present invention. The interactive learning system comprises a plurality of sensing/transmitting modules 10a, 10b, 10c, 10d, 10e and 10f, and a data processing device 20.

The sensing/transmitting modules 10a-10f may be connected in a wired or wireless manner, in order to constitute a sensing network 10. In an embodiment of the present invention, the wired manner includes Universal Asynchronous Receiver/Transmitter (UART), Inter-Integrated Circuit (I²C) or Serial Peripheral Interface (SPI), and the wireless manner includes radio frequency (such as Bluetooth, ZigBee and WLAN), infrared rays, and ultrasonic.

Each of the sensing/transmitting modules 10a-10f includes a function module that senses movements and vibrations thereof and interaction statuses between the sensing/transmitting module and the remaining sensing/transmitting modules. In an embodiment of the present invention, the function module may include uni-axis, dual-axis or tri-axis speed sensing module that senses movement, acceleration or vibration statuses thereof, and converts the analog movement, acceleration or vibration statuses into digital data, for the sensing/transmitting modules 10a-10f and the data processing device 20 to process subsequently.

The dotted lines in FIG. 1A indicate that any one of the sensing/transmitting modules 10a-10f may sense interaction statuses between itself and the remaining sensing/transmitting modules.

In an embodiment of the present invention, the sensing/transmitting modules 10a-10f may be connected to one another through wired signal connection ports thereof, and the relative positions and relative relations thereof may be determined by the wired signal connection ports. In another embodiment of the present invention, the sensing/transmitting modules 10a-10f may be connected to one another through wireless signal connection ports thereof, and the relative positions and relative relations thereof may be determined by the wireless signal connection ports.

The data processing device 20 and the sensing/transmitting modules 10a-10f form a transmission network 30. The data processing device 20 receives the interaction messages generated by the sensing/transmitting modules 10a-10f, and displays and/or inputs the interaction messages through a human-machine interface 21.

In the first embodiment, the data processing device 20 and the sensing network 10 may be connected in the wired and/or wireless manner that the sensing/transmitting modules 10a-10f use to constitute the sensing network 10, and constitute the transmission network 30. The sensing/transmitting modules 10a-10f may transmit/receive messages to/from the data processing device 20 through the transmission network 30.

In an embodiment of the present invention, the data processing device 20 is a computer, and the human-machine interface 21 includes a keyboard, a mouse or a display, which allows a user to input information to the data processing device 20, or to watch information.

Note that even if the sensing/transmitting modules 10a-10f constitute the sensing network 10 in a wired manner, the sensing/transmitting modules 10a-10f and the data processing device 20 may constitute the transmission network 30 in a wired or wireless manner, and vice versa.

In operation, as shown in FIG. 1B, the sensing/transmitting modules 10a-10f may be placed on a table, and a user is thus allowed to move the sensing/transmitting modules 10a-10f. For instance, the user may combine the sensing/transmitting modules 10a and 10b. In an embodiment of the present invention, the wired or wireless signal connection ports of the sensing/transmitting modules 10a-10f may be installed on any position thereof, such as edges and corners. If the sensing/transmitting modules 10a-10f are connected in an I²C wired manner, the user may move the sensing/transmitting module 10b to the right-hand side of the sensing/transmitting module 10a, and engage the male connector of the sensing/transmitting module 10a with the female connector of the sensing/transmitting module 10b that are both comply with I²C signal connection ports. As such, the sensing/transmitting modules 10a and 10b may sense the combination status thereof, and transmit messages of the sensed interaction statutes to the data processing device 20 through the transmission network 30. Of course, the sensing/transmitting module 10a may be set to be a master device, and the sensing/transmitting module 10b a slave device, and the interaction statuses sensed by the sensing/transmitting module 10a or 10b may be selected, and transmitted through the transmission network 30 to the data processing device 20. In a case where the sensing/transmitting modules 10a-10f are connected in a wireless manner, e.g., infrared rays, the user may move the sensing/transmitting module 10b to the right-hand side of the sensing/transmitting module 10a, and combine the sensing/transmitting modules 10a and 10b by engaging an infrared transmitter and infrared receiver thereof. As such, the sensing/transmitting modules 10a and 10b may sense the combination status thereof, and transmit the sensed interaction statuses through the transmission network 30 to the data processing device 20.

After the data processing device 20 receives the interaction statuses transmitted from the sensing/transmitting modules 10a and/or 10b, processed messages may be displayed through the human-machine interface 21. For instance, a display function of the human-machine interface 21 may be used to display the combination status of the sensing/transmitting modules 10a and 10b with a figure.

Please refer to FIG. 1C. The sensing/transmitting modules 10a and 10b may be placed at different relative places, and combined with each other in a wired manner that is the same as or different from the wired manner disclosed in the embodiment shown in FIG. 1B. The relative position that is different from what is shown in FIG. 1B may be also transmitted to the data processing device 20 in a way described previously.

### The Second Embodiment

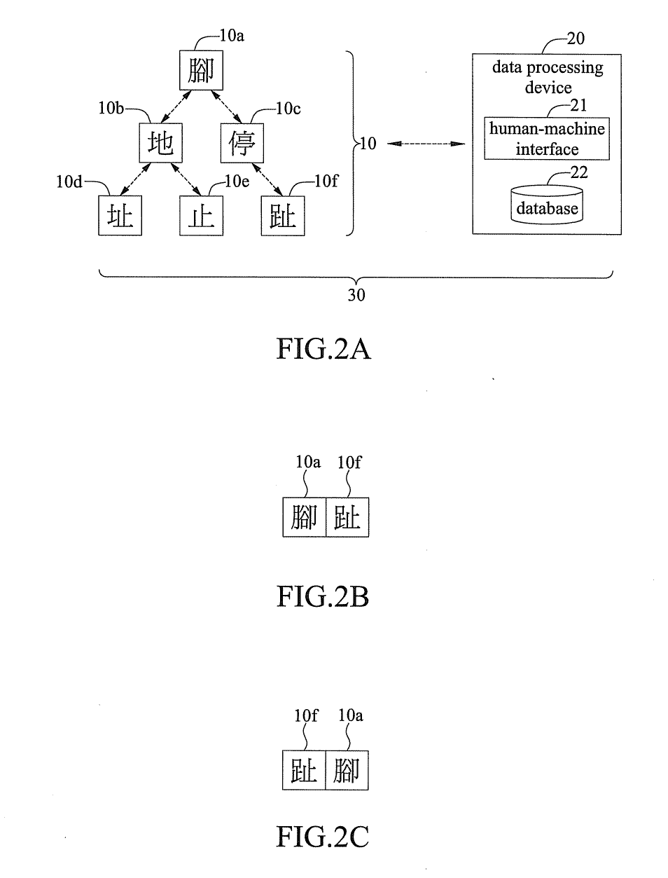

Please refer to FIG. 2A. The second embodiment discloses an application architecture substantially the same as that disclosed in the first embodiment. In the second embodiment, the sensing/transmitting modules 10a-10f may be preset to represent certain learning messages. For instance, the sensing/transmitting modules 10a-10f may represent symbols “ [symbol] ,” “ [symbol] ,” “ [symbol] ,” “ [symbol] ,” “ [symbol] ,” and “ [symbol] ,” respectively. For another instance, the sensing/transmitting modules 10a-10f may represent “demo,” “cracy,” “graphy,” “Biblio,” “graphy” and “pegy,” respectively.

The data processing device 20 may further include a database 22. The database 22 pre-stores identification messages of the sensing/transmitting modules 10a-10f and correlation messages of the sensing/transmitting modules 10a-10f and their corresponding predetermined learning messages. The identification messages provide the data processing device 20 to identify which one of the sensing/transmitting modules 10a-10f moves or operates. The correlation messages provide the data processing device 20 to determine which one of the learning messages to which the sensing/transmitting modules 10a-10f correspond. For instance, the sensing/transmitting modules 10a-10f may represent “ [symbol] ,” “ [symbol] ,” “ [symbol] ,” “ [symbol] ,” “ [symbol] ,” and “ [symbol] ,” respectively. For another instance, the sensing/transmitting modules 10a-10f may represent “demo,” “cracy,” “graphy,” “Biblio,” “logy” and “pegy,” respectively.

After receiving the interaction messages of the sensing/transmitting modules 10a-10f, the data processing device 20 generates learning status messages according to the interaction messages, the identification messages and the correlation messages, and displays the learning status messages through the human-machine interface 21. The learning status messages may indicate how a user combines the sensing/transmitting modules 10a-10f and a combining process.

It may be observed whether a user correctly combines ‘ [symbol] ’ with “ [symbol] ,” “ [symbol] ” with “ [symbol] ,” or “ [symbol] ” with “ [symbol] ,” or whether an error occurs during the combining process. The so-called “correctly combines” includes the relative positions of the sensing/transmitting modules 10a-10f. The combining of “ [symbol] ” with “ [symbol] ” represents that the sensing/transmitting module 10b representing “ [symbol] ” is placed at the right-hand side of the sensing/transmitting module 10a representing “ [symbol] ,” as shown in FIG. 2B. On the contrary, FIG. 2C shows that the sensing/transmitting module 10b representing “ [symbol] ,” is place at the left-hand side of the sensing/transmitting module 10a representing “ [symbol] ,” which is read, from left to right, as “ [symbol] [symbol] ,” which is incorrectly. During the combining process, the learners' conceptions may be determined. For instance, the learner's conceptions and a process during which errors occur may be understood by observing a combining process in which “ [symbol] ” combines first with “ [symbol] ” first, and then with “ [symbol] ” and last with “ [symbol] .” The learning status messages may be stored in the database 22.

In addition to the above symbols and English phrases (e.g., it may be determined whether “demo” and “cracy” are combined correctly), words, idioms or even sentences may be applied in the interactive learning system of the present invention. With regard to the professional fields, the learning data may include history, society, physics, chemistry, biology, etc.

### The Third Embodiment

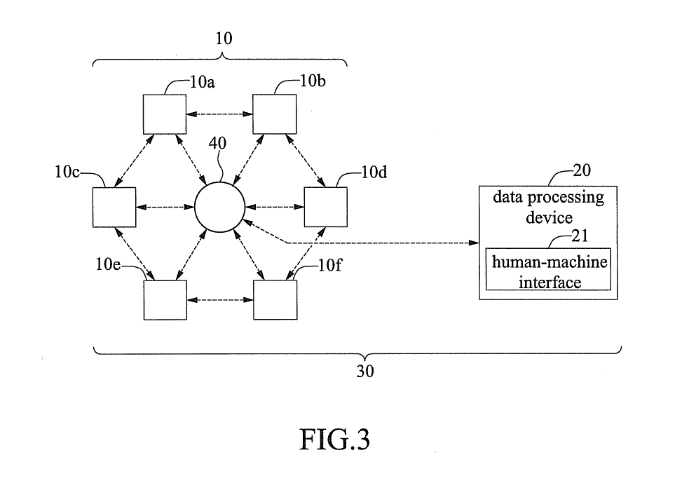

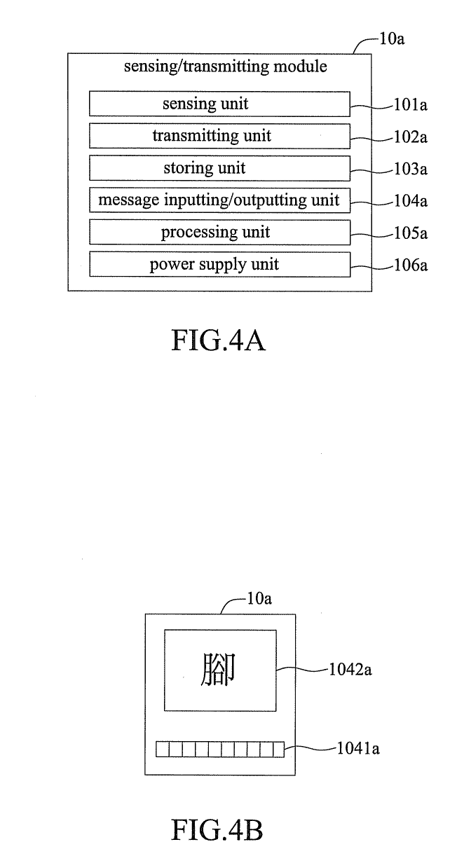

Please refer to FIG. 3. The third embodiment has an application architecture substantially the same as that of the first embodiment, and may be also applied to the second embodiment. In the third embodiment, the interactive learning system of the present invention further comprises an intermediate module 40 that interfaces the sensing/transmitting modules 10a-10f to the data processing device 20, and converts messages generated by the sensing/transmitting modules 10a-10f and the data processing device 20 into another messages in a format readable by the sensing/transmitting modules 10a-10f and the data processing device 20. Therefore, the sensing/transmitting modules 10a-10f may transmit/receive the another messages to/from the data processing device 20.

The intermediate module 40 may be connected to the sensing/transmitting modules 10a-10f in a wired or wireless manner, and acts as a network coordination point of the sensing network 10 constituted by the sensing/transmitting modules 10a-10f. On the other hand, the intermediate module 40 is further connected to the data processing device 20 in a wired or wireless manner. Therefore, the intermediate module 40 may receive messages transmitted from the sensing/transmitting modules 10a-10f, and convert the messages into another messages in a format readable by the data processing device 20. The intermediate module 40 may also receive data transmitted from the data processing device 20, and convert the data into another data in a format readable by the sensing/transmitting modules 10a-10f.

In an embodiment of the present invention, the intermediate module 40 and the sensing/transmitting modules 10a-10f may be connected in a wired or wireless manner, and form a star (as shown in FIG. 3) or a tree network topology.

### The Fourth Embodiment

The fourth embodiment is more detailed than the first to third embodiments. In the fourth embodiment, only the sensing/transmitting module 10a is illustrated for simplicity, and the remaining sensing/transmitting modules 10b-10f also have the same configurations.

The sensing/transmitting module 10a comprises a sensing unit 101a, a transmitting unit 102a, a storing unit 103a, a message inputting/outputting unit 104a, a processing unit 105a and a power supply unit 106a.

The sensing unit 101a senses movements and vibrations of the sensing/transmitting module 10a and interaction statuses between the sensing/transmitting module 10a and remaining sensing/transmitting modules 10b-10f. The sensing unit 101a may be a uni-axis, dual-axis or tri-axis speed sensing module that may sense analog movements, accelerations and vibrations of the sensing/transmitting module 10a, and convert the analog movements, accelerations and vibrations into digital data, for the sensing/transmitting module 10a and the data processing device 20 to process subsequently.

The transmitting unit 102a may transmit/receive messages to/from the remaining sensing/transmitting modules 10b-10f in a wired or wireless manner. The wired manner includes UART, I²C and SPI, and the wireless manner includes radio frequency (such as Bluetooth, ZigBee and WLAN), infrared rays, and ultrasonic. The transmitting unit 102a may include wired or wireless signal connection ports that correspond to the above specification.

The storing unit 103a stores messages predetermined or received through the transmitting unit 102a. The storing unit 103a may be a non-volatile storing unit, such as a flash memory or EEPROM.

The message inputting/outputting unit 104a is used for inputting operation instructions, and displaying statuses of the sensing/transmitting module 10a itself. The message inputting/outputting unit 104a includes keys and/or switches 1041a that are used for inputting the operation instructions, and a liquid crystal display 1042a that displays the statuses of the sensing/transmitting module 10a itself.

The processing unit 105a processes messages of the sensing unit 101a, the transmitting unit 102a, the storing unit 103a and the message inputting/outputting unit 104a.

The power supply unit 106a provides power to the sensing unit 101a, the transmitting unit 102a, the storing unit 103a, the message inputting/outputting unit 104a and the processing unit 105a. The power supply unit 106a may include a battery module.

Given the above, an interactive learning system of the present invention constitutes a sensing network through a plurality of sensing/transmitting modules, and constitutes a transmission network with a data processing device. The sensing/transmitting modules sense movements and vibrations thereof and interaction statuses between the sensing/transmitting modules and other sensing/transmitting modules, and generate messages that indicate the movements, the vibrations and the interaction statuses. The sensing/transmitting modules transmit the messages through the transmission network to the data processing device, and a human-machine interface of the data processing device displays the interaction messages. As such, learners' conceptions can be perceived and presented by the actual operations of the sensing/transmitting modules, which allows teachers to grasp learners' conceptions and thereby increase their interactions.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. An interactive learning system, comprising:
a plurality of sensing/transmitting modules that constitute a sensing network, the sensing/transmitting modules sensing movements and vibrations thereof and interaction statuses between the sensing/transmitting modules and other sensing/transmitting modules, so as to generate interaction messages that indicate the movements, the vibrations and the interaction statuses; and
a data processing device that forms a transmission network together with the sensing/transmitting modules, the data processing device receiving the interaction messages generated by the sensing/transmitting modules, and displaying and/or inputting the interaction messages through a human-machine interface.

2. The interactive learning system of claim 1, wherein the sensing/transmitting modules correspond to predetermined learning messages, and the data processing device comprises a database that is used for pre-storing identification messages of the sensing/transmitting modules and correlation messages of the sensing/transmitting modules and their corresponding predetermined learning messages, and wherein the data processing device, upon receiving the interaction messages, further generates learning status messages according to the interaction messages, the identification messages and the correlation messages, and displays the learning status messages through the human-machine interface, the learning status messages being further stored in the database.

3. The interactive learning system of claim 1, further comprising an intermediate module that interfaces the sensing/transmitting modules with the data processing device, and converts messages generated by the sensing/transmitting modules and the data processing device into another messages in a format readable by the sensing/transmitting modules and the data processing device, so as to allow the another messages to be transmitted between the sensing/transmitting modules and the data processing device.

4. The interactive learning system of claim 3, wherein the intermediate module and the sensing/transmitting modules form a star or a tree network topology.

5. The interactive learning system of claim 4, wherein the intermediate module is connected to the sensing/transmitting modules in a wired manner.

6. The interactive learning system of claim 4, wherein the intermediate module is connected to the sensing/transmitting modules in a wireless manner.

7. The interactive learning system of claim 1, wherein each of the sensing/transmitting modules comprises:
a sensing unit that senses the movements and vibrations of the sensing/transmitting modules and the interaction statuses between the sensing/transmitting modules and the other sensing/transmitting modules;
a transmitting unit that transmits/receives messages to/from the other sensing/transmitting modules;
a storing unit that stores predetermined messages or messages received through the transmitting unit;
a message inputting/outputting unit that allows operation instructions to be input therein and displays a status of the sensing/transmitting module itself;
a processing unit that processes messages of the sensing unit, the transmitting unit, the storing unit and the message inputting/outputting unit; and
a power supply unit that supplies power to the sensing unit, the transmitting unit, the storing unit, the processing unit and the message inputting/outputting unit.

8. The interactive learning system of claim 7, wherein the message inputting/outputting unit comprises keys and/or switches for inputting the operation instructions, and a liquid crystal display for displaying the status of the sensing/transmitting module itself.

9. The interactive learning system of claim 1, wherein the human-machine interface comprises a displaying unit that displays messages, and an inputting unit that allows messages to be input therein.

10. The interactive learning system of claim 1, wherein the sensing/transmitting modules constitute the sensing network in a wired manner.

11. The interactive learning system of claim 1, wherein the sensing/transmitting modules constitute the sensing network in a wireless manner.

12. The interactive learning system of claim 1, wherein the sensing/transmitting modules and the data processing device form the transmission network in a wired manner.

13. The interactive learning system of claim 1, wherein the sensing/transmitting modules and the data processing device form the transmission network in a wireless manner.

14. The interactive learning system of claim 1, wherein the sensing/transmitting modules receive messages through the data processing device via the transmission network.
